(19) United States
(12) Patent Application Publication
(10) Pub. No.: US 2023/0400686 A1
(43) Pub. Date: Dec. 14, 2023

(54) HEAD-UP DISPLAY DEVICE

(71) Applicant: NIPPON SEIKI CO., LTD., Niigata (JP)

(72) Inventors: Tetsuta HIGUCHI, Niigata (JP); Akitoshi KOSHIBA, Niigata (JP)

(21) Appl. No.: 18/328,941

(22) Filed: Jun. 5, 2023

(30) Foreign Application Priority Data
Jun. 13, 2022 (JP) 2022-095261

(51) Int. Cl. G02B 27/01

(52) U.S. Cl. CPC G02B 27/0101

(57) ABSTRACT

To provide a head-up display device including a mirror that is less likely to deform. A head-up display device according to an embodiment includes: a display unit which emits display light; a base material which includes an adhesive surface and is formed of a synthetic resin material containing a fiber filler; and an optical film which is adhesively attached to the adhesive surface and reflects the display light, in which when a first direction and a second direction that are orthogonal to each other are defined in directions of the adhesive surface, the optical film tends to linearly expand in the second direction in the directions of the adhesive surface, and the base material tends to linearly expand in the second direction in the directions of the adhesive surface.

### TECHNICAL FIELD

The present invention relates to a head-up display device.

### BACKGROUND ART

Patent Document 1 discloses a mirror used for a head-up display device. The mirror is a concave mirror (40) including a base body (41). It is disclosed that a resin such as polycarbonate is adopted for the base body (41). The base body (41) includes, on a surface thereof, a reflection film (60) formed by vacuum deposition.

Patent Document 2 discloses a mirror used for a head-up display device. The mirror is a reflecting mirror (4) including a reflection layer (41) that is formed of layers of a plurality of resin films each having a different refractive index, an adhesive layer (42), and a base material (43) to which the reflection layer (41) is bonded via the adhesive layer (42).

### PRIOR ART DOCUMENT

### Patent Document

Patent Document 1: JP 2021-76859 A
Patent Document 2: WO 2020/246546

### SUMMARY OF INVENTION

### Technical Problem

The inventors of the present invention have found that deformation occurs when a mirror obtained by combining the conventional configurations indicated in the above patent documents is used. Therefore, there is room for improvement in yield strength against deformation with respect to the mirror having the conventional configurations. Hence, an object of the present invention is to provide, in light of the problem mentioned above, a head-up display device including a mirror which is improved to be less likely to deform, when an optical film is adhesively attached to a base material.

### Solution to Problem

In order to achieve the above object, a head-up display device of the present disclosure includes: a display unit which emits display light; a base material which includes an adhesive surface and is formed of a synthetic resin material containing a fiber filler; and an optical film which is adhesively attached to the adhesive surface and reflects the display light. When a first direction and a second direction that are orthogonal to each other are defined in directions of the adhesive surface, the optical film tends to linearly expand in the second direction in the directions of the adhesive surface, and the base material tends to linearly expand in the second direction in the directions of the adhesive surface.

In particular, in the head-up display device, the optical film reflects, among beams of incident light, first direction visible polarized light, and transmits or absorbs second direction visible polarized light.

Further, from another perspective, in order to achieve the above object, a head-up display device of the present disclosure includes: a display unit which emits display light; a base material which includes an adhesive surface and is formed of a synthetic resin material containing a fiber filler; and an optical film which is adhesively attached to the adhesive surface and reflects the display light. When a first direction and a second direction that are orthogonal to each other are defined in directions of the adhesive surface, the optical film tends to linearly expand in the second direction in the directions of the adhesive surface, and the base material includes a gate in the first direction in the directions of the adhesive surface.

In particular, in the head-up display device, the optical film reflects, among beams of incident light, first direction visible polarized light, and transmits or absorbs second direction visible polarized light.

Furthermore, from another perspective, in order to achieve the above object, a head-up display device of the present disclosure includes: a display unit which emits display light; a base material which includes an adhesive surface, is formed of a synthetic resin material containing a fiber filler, and is of a substantially rectangular shape; and an optical film which is adhesively attached to the adhesive surface and reflects the display light. When a longer-side direction and a shorter-side direction are defined in directions of the adhesive surface, the optical film reflects, among beams of incident visible light, longer-side direction visible polarized light, and transmits or absorbs shorter-side direction visible polarized light, and the base material includes a gate at a place corresponding to the center of the short side of the base material.

Furthermore, from another perspective, in order to achieve the above object, a head-up display device of the present disclosure includes: a display unit which emits display light; a base material which includes an adhesive surface, is formed of a synthetic resin material containing a fiber filler, and is of a substantially rectangular shape; and an optical film which is adhesively attached to the adhesive surface and reflects the display light. When a longer-side direction and a shorter-side direction are defined in directions of the adhesive surface, the optical film reflects, among beams of incident visible light, longer-side direction visible polarized light, and transmits or absorbs shorter-side direction visible polarized light, and the base material includes gates respectively provided at places corresponding to the center of both of long sides of the base material.

Furthermore, from another perspective, in order to achieve the above object, a head-up display device of the present disclosure includes: a display unit which emits display light; a base material which includes an adhesive surface, is formed of a synthetic resin material containing a fiber filler, and is of a substantially rectangular shape; and an optical film which is adhesively attached to the adhesive surface and reflects the display light. When a longer-side direction and a shorter-side direction are defined in directions of the adhesive surface, the optical film reflects, among beams of incident visible light, longer-side direction visible polarized light, and transmits or absorbs shorter-side direction visible polarized light, and the base material includes a gate only at a place corresponding to the center of one of long sides of the base material.

In particular, in the head-up display devices as described above, the optical film transmits incident infrared light.

In particular, in the head-up display devices as described above, the optical film is formed of a dielectric multilayer film.

In particular, in the head-up display devices as described above, the fiber filler comprises a carbon fiber or a glass fiber.

### BRIEF DESCRIPTION OF DRAWINGS

FIG. 1 is a schematic cross-sectional view illustrating the configuration of a head-up display device according to an embodiment of the present invention.

FIG. 2 is a perspective view illustrating a mirror provided in the head-up display device.

FIG. 3 is a diagram illustrating a cross section of the essential part of a mirror 4.

FIG. 4 is a front view of a base material 40.

FIG. 5A is a front view of a base material 400.

FIG. 5B is a diagram illustrating the directivity of fiber fillers contained in the base material 400.

FIG. 6 is a front view of a base material 401.

FIG. 7 is a front view of a base material 402.

### DESCRIPTION OF EMBODIMENTS

In the following, a head-up display device of the present disclosure will be described as an example to describe embodiments and modifications, and the description will be given in the order below with reference to the accompanying drawings. Note that, for simplicity, reference numerals may be assigned to only some of the parts having the same attribute that exist in a plurality of figures.
[1. First Embodiment]
1-1. Description of Configuration
1-2. Description of Mirror 4
1-3. Description of Adhesive Surface 40a
1-4. Description of Gate G1 and Linear Expansion
1-5. Examples of Advantageous Effects
[Second Embodiment]
[Third Embodiment]
[Modifications]

### First Embodiment

<1-1. Description of Configuration>

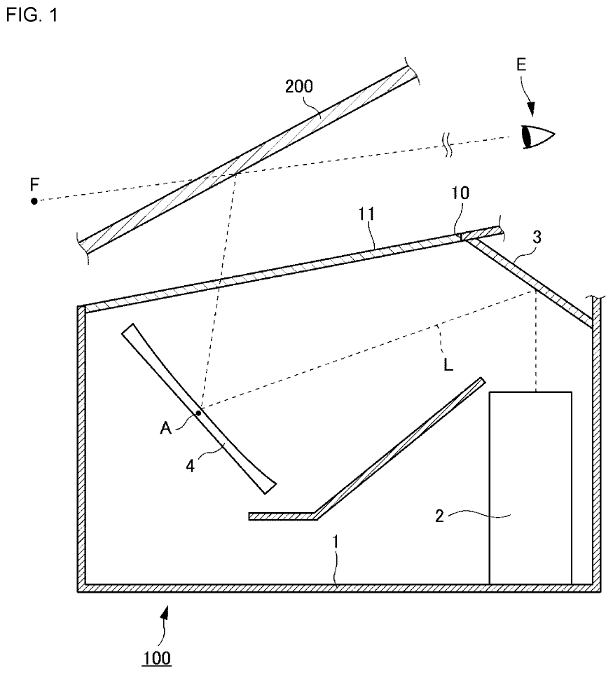

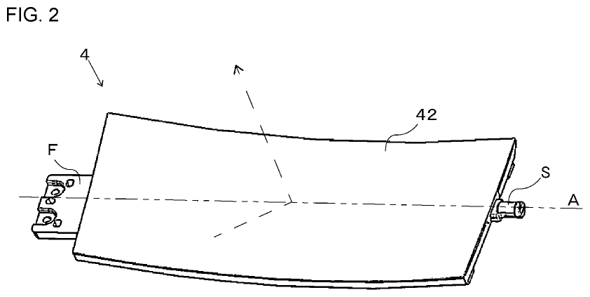

A head-up display device 100 is a device mounted on a car, for example, and includes, as illustrated in FIGS. 1 and 2, a housing 1, a display unit 2, a plane mirror 3, a mirror 4, a mirror rotation mechanism 5, and a circuit board which is not shown.

The head-up display device 100 reflects, by means of the plane mirror 3 and the mirror 4, display light L emitted by the display unit 2 which indicates a predetermined image, and irradiates a windshield 200 of a vehicle in which the head-up display device 100 is mounted with the reflected light, thereby displaying the image. Contents of display by the head-up display device 100 are vehicle information such as the traveling speed of the vehicle and various warnings, navigation information, and the like.

The housing 1 is formed of, for example, a black synthetic resin, and accommodates therein the display unit 2, the plane mirror 3, the mirror 4, the mirror rotation mechanism 5, and the circuit board (not shown). An opening portion 10, which allows the display light L to be described later to pass through toward the windshield 200 (a transmissive reflection member), is formed at a part of the housing 1 facing the windshield 200, and the opening portion 10 is covered with a translucent cover 11.

The display unit 2 emits the display light L which indicates an image (i.e., a notification image) for notifying predetermined information (various kinds of vehicle information and navigation information, etc.), and is configured from, for example, a transmissive liquid crystal display composed of a liquid crystal panel and a light source for backlight, or a self-luminous display.

The plane mirror 3 reflects the display light L emitted by the display unit 2 toward the mirror 4.

The mirror 4 further reflects the display light L reflected from the plane mirror 3, and emits the display light L toward the windshield 200. The mirror 4 is configured as a concave mirror which is formed by using an adhesion layer to bond an optical film (a reflection layer) to a surface of a base material made of a synthetic resin material. The mirror 4 is provided with a shaft portion S and a flange portion F on both end portions in the direction of a rotation axis line A. The flange portion F is a place where a shaft portion (not shown) that can slide and rotate about the rotation axis line A is mounted. The mirror 4 rotates about the direction of the rotation axis line A in which the shaft portion serves as a fulcrum, thereby adjusting a reflection angle of the display light L. The mirror 4 will be described in detail later.

The display light L reflected from the mirror 4 passes through the translucent cover 11 provided over the opening portion 10 of the housing 1, and travels toward the windshield 200. The display light L which has reached the windshield 200 and is reflected by the windshield 200 forms a virtual image of the notification image (i.e., a display image visually recognized by an observer E) at a virtual image position V (see FIG. 1) ahead of the windshield 200, and also, light from the front side is transmitted. Consequently, the head-up display device 100 can allow the observer E (mainly a driver of the vehicle) to visually recognize both the virtual image and outside scenery, etc., which actually exists ahead of the vehicle.

The mirror rotation mechanism 5 rotates the mirror 4 about the rotation axis line A and is configured from, for example, a bearing member which supports the shaft portion and a rotation drive portion. The rotation drive portion is provided with a frame, a motor, a lead screw shaft, and a lead member. The frame fixes and supports the motor and also rotatably supports the lead screw shaft. Further, the frame restricts rotation of the lead member about the lead screw shaft. The motor is a stepping motor which generates a driving force for rotating the mirror 4 about the rotation axis line A. The lead screw shaft is coupled to an output shaft of the motor and rotates in a normal direction or a reverse direction in accordance with the drive of the motor. The lead member is provided with a screw portion which is screwed onto the lead screw shaft, and a coupling portion which is coupled to a coupling lever portion of a shaft member in abutment with the coupling lever portion. When the lead screw shaft is rotated in accordance with the drive of the motor, the lead member whose rotation about the lead screw shaft is restricted by the frame is moved along the axis line of the lead screw shaft. Consequently, as the mirror 4 is pushed via a protrusion provided on the mirror 4, for example, the mirror 4 is rotated about the rotation axis line A and a reflection angle of the mirror 4 is changed.

The circuit board, not shown, is a printed circuit board which is disposed, for example, at a predetermined position in the housing 1 and on which a control portion (not shown), which is composed of a microcontroller obtained by combining a computation device such as a CPU, a RAM, and a ROM, etc., and a storage device, is mounted. The control portion of the circuit board is electrically connected to each of the display unit 2 and the rotation drive portion. The control portion acquires vehicle state information transmitted from an external device (not shown), such as a vehicle electronic control unit (ECU), through a communication line, and drives the display unit 2 according to the acquired state information (in other words, causes the display unit 2 to display a predetermined notification image). Further, the head-up display device 100 is provided with input means (not shown) for enabling a user, i.e., the observer E, for example, to adjust the angle of the mirror 4 (here, the input means may be an external device of the head-up display device 100 electrically connected to the control portion). The control portion drives the rotation drive portion in accordance with the content of operation by the user via the input means, and rotates the mirror 4 about the rotation axis line A by a predetermined angle. By the adjustment of the angle of the mirror 4 described above, a virtual image can be displayed at an appropriate position corresponding to the height of the line of sight of a person on board.

<1-2. Description of Mirror 4>

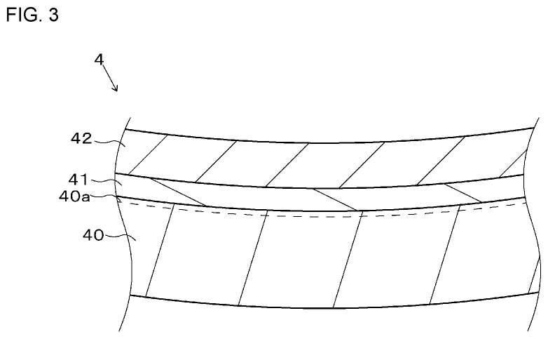

In this section 1-2, the mirror 4, in particular, will be described in detail. FIG. 3 is a diagram which illustrates a cross section of the essential part of the mirror 4 on a plane including the rotation axis line A and an optical film 42 (a reflection layer). The mirror 4 is a concave mirror which is formed by using an adhesion layer 41 to adhesively attach the optical film 42 to a surface of a base material 40 made of a synthetic resin material.

As the synthetic resin material of the base material 40, a material having high fluidity and high rigidity is selected. A synthetic resin material having high fluidity enhances formability (the accuracy of a surface shape, etc.) of the mirror 4. A synthetic resin material having high rigidity enhances yield strength of the mirror 4 against a vibration. From the above standpoint, cyclic olefin-based resin and polycarbonate are selected for the synthetic resin material. Specific examples of the cyclic olefin-based resin include cycloolefin polymer (COP) and cyclic olefin copolymer (COC).

Further, the base material 40 may also be formed of a crystalline heat-resistant polymer, and the like. More specifically, engineering plastics such as polybutylene terephthalate (PBT), polyethylene terephthalate (PET), polyacetal (POM), polyamide (PA), modified polyphenylene ether (m-PPE), and polyphenylene sulfide (PPS) may be used.

Note that the synthetic resin material which may be applied for the base material 40 is shaped in such a state that fillers are contained, as will be described below.

In a first embodiment, the base material 40 should preferably be in a dark color, in particular. The base material 40 in a dark color can decrease the possibility of reflecting light toward the observer E or the display unit 2 even when light which can pass through the optical film 42 is made incident on the optical film 42.

The adhesion layer 41 is provided on one side (i.e., a surface) of the base material 40. The adhesion layer 41 adhesively attaches the optical film 42 to the base material 40. Although various adhesives may be applied for the adhesion layer 41, an optical clear adhesive (OCA) or an optical clear resin (OCR), for example, may be used. A double-sided adhesive tape, an epoxy resin, and a hardening agent may also be used. An acrylic gluing agent, in particular, is suitable for the adhesion layer 41. Using the acrylic gluing agent is a suitable configuration since acrylic gluing agents can be manufactured at low cost while ensuring adhesive properties appropriate for various optical films.

The optical film 42 is a reflection member which reflects the display light L emitted by the display unit 2. The optical film 42 may be a mirror film which totally reflects the display light L. The optical film 42 may be a cold mirror film, in particular. A polarized light reflective cold mirror film is a mirror film formed of a dielectric multilayer film, and corresponds to a selective light reflection optical film which reflects, among beams of incident light, only visible light corresponding to polarized light polarized in a certain direction, and transmits the other light. The polarized light reflective cold mirror film prevents, of sunlight entering from the outside, polarized light polarized in a direction different from that of the display light L and infrared light from reaching the display unit 2, etc., and heating the display unit 2, etc. The optical film 42 may be a visible light reflection film that has no polarization properties.

<1-3. Description of Adhesive Surface 40a>

The adhesion layer 41 is provided on an adhesive surface 40a, which is particularly the surface of the base material 40. The adhesive surface 40a is configured in the following manner in order to realize a mirror in which the optical film 42 is more firmly bonded to the base material 40.

On the adhesive surface 40a, a protective layer containing silicon is formed. Although it suffices that the adhesive surface 40a is a protective layer that belongs to vitrified coating, preferably, the adhesive surface 40a should be a protective layer containing, for example, silicon dioxide or silicon monoxide.

On the adhesive surface 40a, the above-described protective layer may be formed by an arbitrary method. For example, the protective layer is formed as a result of combustion of a silane compound which has been added to a surface corresponding to the adhesive surface 40a of the base material 40.

Here, a problem in a conventional configuration found by the inventors of the present invention will be described. The inventors of the present invention have found that, in a conventional mirror provided with an optical film that is adhesively attached to a base material by an adhesion layer, there is a possibility that an air bubble and peeling may occur in the optical film under a specific condition. The inventors of the present invention have identified that such a phenomenon occurs when volatilized gas from the base material enters the interface between the adhesion layer and the base material. In most cases, the volatilized gas is water vapor produced as moisture included in the base material is vaporized. Such vaporization occurs particularly after the base material has been injection molded or the like or when the base material is exposed to a high-temperature environment. Note that the volatilized gas may be some kind of a gas other than water vapor.

In order to resolve the above phenomenon, it is possible to use a special adhesion layer which prevents entry of the volatilized gas. However, a manufacturing cost of such a high-performance adhesion layer is often high, and it is difficult to adopt such an adhesion layer.

Thus, the adhesive surface 40a, which is the protective layer as described above, is applied to the mirror 4 of the present disclosure. In a configuration in which the protective layer is provided on the surface of the base material 40 as described above, even if volatilized gas is produced from inside the base material 40, the volatilized gas that passes through the adhesive surface 40a is significantly reduced, and the possibility of having conspicuous air bubbles and peeling at the interface between the base material 40 and the adhesion layer 41 can be reduced. In this case, the volatilized gas is released to the surroundings from a surface other than the adhesive surface 40a.

The mirror 4 provided with the adhesive surface 40a which has been formed in this way is a mirror in which a reflection layer is more firmly bonded to a base material while an increase in cost is suppressed.

<1-4. Description of Gate and Linear Expansion>

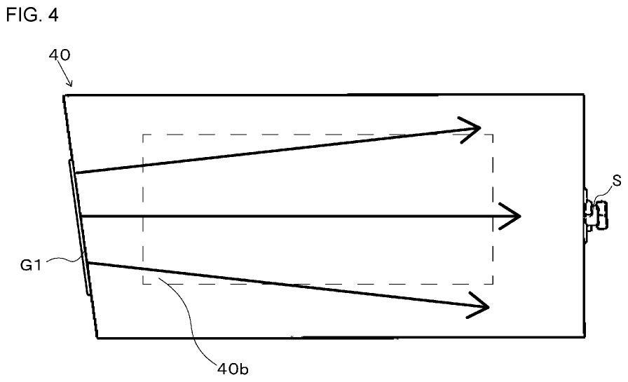

FIG. 4 is a front view of the base material 40. In FIG. 4, the flange portion F is omitted from the illustration. The flange portion F may be provided on the base material 40 or may be formed on a mirror holder, which is a separate body. The base material 40 is manufactured by having a synthetic resin material injection molded using a mold. More specifically, the base material 40 is manufactured by filling a molten synthetic resin material into a mold, which is a set of articles consisting of a cavity and a core, and pressurizing the synthetic resin material.

On the base material 40, a gate G1 is formed. In performing the injection molding, a molten synthetic resin material is filled such that the synthetic resin material spreads over the entire base material 40 through this gate. The molten synthetic resin material is filled according to routes indicated by arrow lines shown in FIG. 4. A direction indicated by the arrow line may also be referred to as a Machine Direction (direction MD), and a direction orthogonal to the Machine Direction may also be referred to as a Transverse Direction (direction TD). The direction MD may also be referred to as a filling direction.

The gate G1 is formed at a place (a side surface) corresponding to a short side of the base material 40 forming a substantially rectangular shape or at the flange portion F or the like. In particular, the gate G1 is provided at the center of the side surface on the short side of the mirror 4. The gate G1 is formed to have a width of approximately one-quarter or more of the length of the short side.

Also, the synthetic resin material of the base material 40 contains fillers (a filler material). The fillers improve the strength of a main component synthetic resin material, in particular, and are fibrous fillers (fiber fillers), in particular. A carbon fiber and a glass fiber, for example, are suitable for such fiber fillers.

In a mirror in which a reflection film is formed by vapor deposition as in conventional mirrors, unevenness is caused by the fillers, and reflection accuracy of display light is lowered. For this reason, this type of mirror is not suitable. However, in a mirror in which an optical film to be adhesively attached forms a reflection film as in the present configuration, unevenness caused by the fillers is absorbed by the adhesion layer and the optical film itself, and the effect of the unevenness can be reduced to a negligible level.

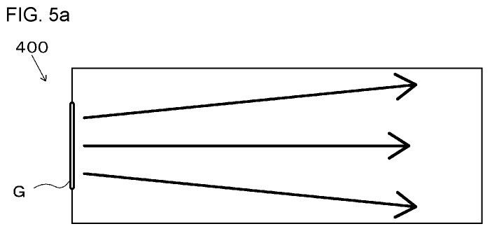

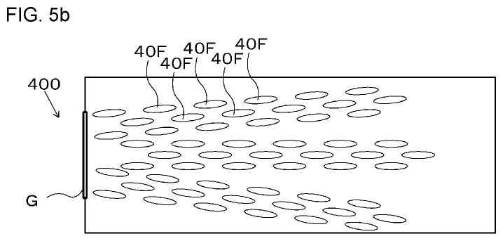

FIGS. 5A and 5B show the state in which a synthetic resin material containing fiber fillers is filled into a base material 400 of a rectangular shape through a gate G. The synthetic resin material filled from the gate G is filled according to routes indicated by arrows shown in FIG. 5A. At this time, a distal end of a filler 40F, which is in the form of a fine fiber, tends to be oriented in the direction MD.

The base material 400 containing oriented fillers 40F exhibits an anisotropy in a linear expansion coefficient when a temperature change occurs. Specifically, linear expansion does not tend to occur (i.e., a linear expansion coefficient is small) in the direction MD in which the fillers 40F are oriented, and linear expansion tends to occur (i.e., a linear expansion coefficient is large) in the direction TD which is orthogonal to the direction in which the fillers 40F are oriented. In other words, in the base material 400 configured as illustrated in FIG. 5B, linear expansion does not tend to occur in a crosswise direction in the drawing, and the linear expansion tends to occur in a lengthwise direction in the drawing (and a perpendicular direction to the plane of the drawing).

Here, the characteristics of the optical film 42 will be described. There exist optical films of a type which exhibits an anisotropy in the linear expansion coefficient in an in-plane direction of the film. Particularly, a tendency as described above is remarkable in the optical films which exhibit polarization properties. For example, a visible polarized light reflective cold mirror film which reflects, among beams of incident light, visible light (first direction visible polarized light) traveling along a first direction (a reflection axis) in the plane of the film, and transmits or absorbs the other light (including visible light and infrared rays, etc.,) is known as the optical film. In terms of a film plane direction, the film does not tend to linearly expand in the first direction and tends to linearly expand in a second direction orthogonal to the first direction. For example, some visible polarized light reflective cold mirror films have a linear expansion coefficient of about 0.3 [10\hat{ }(−5)/° C.] in the first direction and about 10[10\hat{ }(−5)/° C.] in the second direction. A tendency as described above is not a characteristic limited to the visible polarized light reflective cold mirror film, but is also acknowledged in many optical films having polarization properties such as a polarizing plate and a polarizing reflector.

Therefore, in the mirror 4 of the first embodiment, by adhesively attaching the optical film 42 to the base material 40 which has been formed as illustrated in FIG. 4 with the first direction (reflection axis) being made to conform to the crosswise direction in the drawing, tendencies of a linear expansion ratio in the directions of the adhesive surface 40a conform to each other. The mirror 4 in which the base material 40 and the optical film 42 are adhesively attached such that the tendencies of the linear expansion ratio of the base material 40 and the optical film 42 conform to each other can reduce warping and curvature which are caused by a difference in the linear expansion of the two when a temperature change occurs.

Particularly, in the mirror 4 which is a free-form surface mirror, conformity in the tendencies of the linear expansion ratio brings about a significant advantage. The mirror 4, which is a concave mirror, reflects the display light L with convergence and divergence. In the mirror 4 as described above, if the tendencies of the linear expansion ratio do not conform to each other in a plane direction, a balance between the converging effect and the diverging effect in vertical and horizontal directions of the mirror is lost, and the quality of the display light L (visual quality and directivity, etc.) is significantly deteriorated. In particular, when vertical/horizontal magnification becomes unbalanced, a virtual image visually recognized by the observer E may be seen doubled or blurred. Therefore, in the mirror 4, which is a free-form surface mirror, by achieving conformity in the tendencies of the linear expansion ratio, a head-up display device with improved display quality can be obtained.

Although the filling direction of the base material 40 is shown by the arrow line in FIG. 4, a specific filling direction also exists at a place not illustrated. In some places not illustrated (an outer edge portion of the base material 40, in particular), there may be a place where the direction does not necessarily correspond to a direction of satisfying conformity in the tendencies of the linear expansion ratio due to turning of the resin. Even in such a case, if the linear expansion characteristics of the base material 40 as a whole in actual measurement are configured as described above, the advantages described in the present disclosure can be achieved after all. Also, if the gate G1 is formed as described above, the above-described preferred linear expansion characteristics will be exhibited.

Although the desired filling direction is difficult to be achieved at the outer edge portion of the base material 40, it is particularly desirable that the filling direction should be the desired direction at least in an area 40b within the adhesive surface 40a. The area 40b is an area where, when a space where the observer E can visually recognize a virtual image is defined as an eyebox, the display light L which will reach the center of the eyebox is reflected. The display light L reflected at the area 40b, among all beams of the display light L, is perceived by the observer E more frequently than the other light. Therefore, since reflection in the area 40b must be performed accurately, preferably, the tendencies of the linear expansion ratio of the base material 40 and the optical film 42 should conform to each other in the area 40b particularly. More preferably, conformity in the tendencies of the linear expansion ratio should be realized in an area where display light which will reach the overall eyebox is reflected. Further, most preferably, the conformity in the tendencies of the linear expansion ratio should be realized throughout the entire surface of the base material 40.

Further, more preferably, the base material 40 and optical film should conform to each other not only in the tendencies of the linear expansion ratio but also the linear expansion coefficients in the length and width of the two. The mirror 4 configured in this way can significantly reduce deformation which occurs at a temperature change.

<1-5. Examples of Advantageous Effects>

(1) A head-up display device of the present disclosure includes: the display unit 2 which emits the display light L; the base material 40 which includes the adhesive surface 40a and is formed of a synthetic resin material containing a fiber filler; and the optical film 42 which is adhesively attached to the adhesive surface 40a and reflects the display light L. When a first direction (crosswise direction in FIG. 4) and a second direction (lengthwise direction in FIG. 4) that are orthogonal to each other are defined in directions of the adhesive surface 40a, the optical film 42 tends to linearly expand in the second direction in the directions of the adhesive surface 40a, and the base material 40 tends to linearly expand in the second direction in the directions of the adhesive surface 40a.

(2) A head-up display device of the present disclosure includes: the display unit 2 which emits the display light L; the base material 40 which includes the adhesive surface 40a and is formed of a synthetic resin material containing a fiber filler; and the optical film 42 which is adhesively attached to the adhesive surface 40a and reflects the display light L. When a first direction and a second direction that are orthogonal to each other are defined in directions of the adhesive surface 40a, the optical film 42 tends to linearly expand in the second direction in the directions of the adhesive surface 40a, and the base material 40 includes the gate G1 in the first direction in the directions of the adhesive surface 40a.

(3) A head-up display device of the present disclosure includes: the display unit 2 which emits the display light L; the base material 40 which is formed of a synthetic resin material containing a fiber filler and is of a substantially rectangular shape; and the optical film 42 which is adhesively attached to the adhesive surface 40a and reflects the display light L. When a longer-side direction (crosswise direction in FIG. 4) and a shorter-side direction (lengthwise direction in FIG. 4) are defined in directions of the adhesive surface 40a, the optical film 42 reflects, among beams of incident visible light, longer-side direction visible polarized light, and transmits or absorbs shorter-side direction visible polarized light, and the base material 40 includes a gate at a place corresponding to the center of a short side of the base material 40.

According to these configurations, the tendencies of the linear expansion ratio of the base material 40 and the optical film 42 conform to each other in the directions of the adhesive surface 40a. Consequently, a head-up display device including a mirror that is less likely to deform can be obtained.

### Second Embodiment

In this chapter, a head-up display device of the present disclosure will be exemplified in a form different from the above-described embodiment. Detailed descriptions are omitted regarding configurations common to the above embodiment. The present embodiment is different from the above embodiment in the configuration of a base material, in particular.

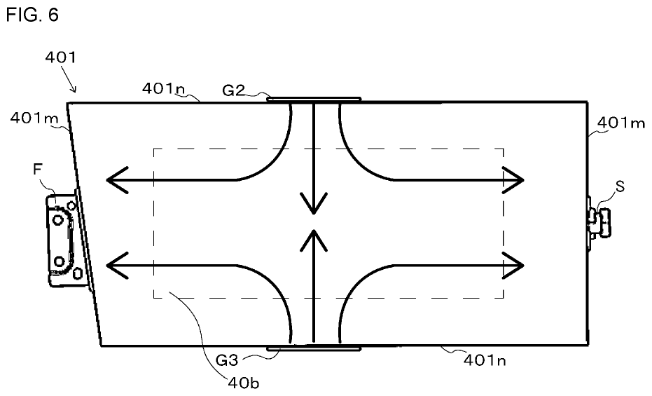

FIG. 6 shows a front view of a base material 401. The base material 401 forms a substantially rectangular shape surrounded by two short sides 401m and two long sides 401n. Gates G2 and G3 are formed at the center of the respective long sides 401n. When the base material is injection molded, a molten synthetic resin material is filled through the gates G2 and G3. The filled synthetic resin material flows in according to routes indicated by arrow lines shown in FIG. 6. When the gates G2 and G3 are formed on the respective long sides, the synthetic resin materials flowing in from the respective gates move toward the center of the base material and then collide with each other, and thereafter move in a longer-side direction. Therefore, when the base material 401 is seen as a whole, a high proportion of filling directions of the synthetic resin material indicates the longer-side direction. In other words, in a broad perspective, an area where fiber fillers are oriented in the longer-side direction is large. The base material 401 configured in this way tends to linearly expand in a shorter-side direction and does not tend to linearly expand in the longer-side direction according to the characteristics indicated in the first embodiment.

Therefore, in the second embodiment, in order to achieve conformity in the tendencies of a linear expansion ratio as in the first embodiment, for an optical film 42, an optical film which tends to linearly expand in the shorter-side direction is used. By doing so, a head-up display device including a mirror that is less likely to deform can be obtained.

While the gates G2 and G3 are to be formed near the center of the respective long sides 401n, the gate width should preferably be approximately one-third or less of the length of the long side. The gates G2 and G3 having such a gate width are particularly suitable because these gates can make an area of the route of the synthetic resin material which is directed in the longer-side direction greater than an area of the same directed in the shorter-side direction.

(4) More specifically, a head-up display device of the present disclosure includes: a display unit 2 which emits display light L; the base material 401 which includes an adhesive surface 40a, is formed of a synthetic resin material containing a fiber filler, and is of a substantially rectangular shape; and the optical film 42 which is adhesively attached to the adhesive surface 40a and reflects the display light L. When a longer-side direction (crosswise direction in FIG. 6) and a shorter-side direction (lengthwise direction in FIG. 6) are defined in directions of the adhesive surface 40a, the optical film 42 reflects, among beams of incident visible light, longer-side direction visible polarized light, and transmits or absorbs shorter-side direction visible polarized light, and the base material 401 includes the gates G2 and G3 respectively provided at places corresponding to the center of both of long sides of the base material 401.

According to these configurations, the tendencies of the linear expansion ratio of the base material 401 and the optical film 42 conform to each other in the directions of the adhesive surface 40a. Consequently, a head-up display device including a mirror that is less likely to deform can be obtained.

### Third Embodiment

In this chapter, a head-up display device of the present disclosure will be exemplified in a form different from the above-described embodiments. Detailed descriptions are omitted regarding configurations common to the above embodiments. The present embodiment is different from the above embodiments particularly in the configuration of a base material.

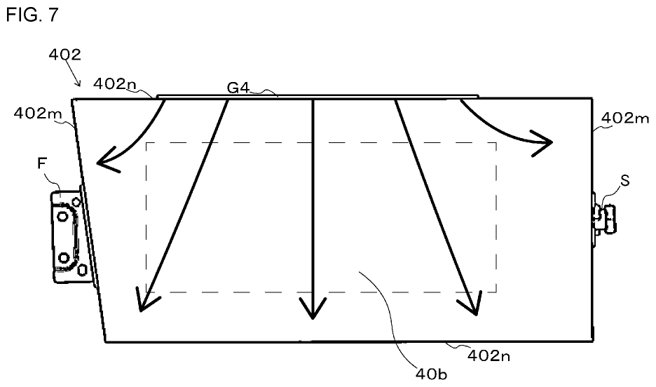

FIG. 7 shows a front view of a base material 402. The base material 402 forms a substantially rectangular shape surrounded by two short sides 402m and two long sides 402n. A gate G4 is formed at the center of one of the long sides 402n. When the base material 402 is injection molded, a molten synthetic resin material is filled through the gate G4. The filled synthetic resin material flows in according to routes indicated by arrow lines shown in FIG. 7. When the gate G4 is formed on one of the long sides, the synthetic resin material flowing in from the gate moves in a shorter-side direction. When the base material 402 is seen as a whole, a high proportion of filling directions of the synthetic resin material indicates the shorter-side direction. In other words, in a broad perspective, an area where fiber fillers are oriented in the shorter-side direction is large. The base material 402 configured in this way tends to linearly expand in a longer-side direction and does not tend to linearly expand in the shorter-side direction according to the characteristics indicated in the first embodiment.

Therefore, in the third embodiment, in order to make the tendencies of a linear expansion ratio conform to the first embodiment, for an optical film 42, an optical film which tends to linearly expand in the longer-side direction is used. By doing so, a head-up display device including a mirror that is less likely to deform can be obtained.

While the gate G4 is to be formed near the center of the long side 402n, the gate width should preferably be at least half the length of the long side. The gate G4 having such a gate width is particularly suitable because this gate can make an area of the route of the synthetic resin material which is directed in the shorter-side direction greater than an area of the same directed in the longer-side direction.

(5) A head-up display device of the present disclosure includes: a display unit 2 which emits display light L; the base material 402 which includes an adhesive surface 40a, is formed of a synthetic resin material containing a fiber filler, and is of a substantially rectangular shape; and an optical film 42 which is adhesively attached to the adhesive surface 40a and reflects the display light L. When a longer-side direction (crosswise direction in FIG. 7) and a shorter-side direction (lengthwise direction in FIG. 7) are defined in directions of the adhesive surface 40a, the optical film 42 reflects, among beams of incident visible light, longer-side direction visible polarized light, and transmits or absorbs shorter-side direction visible polarized light, and the base material includes a gate only at a place corresponding to the center of one of long sides of the base material.

According to these configurations, the tendencies of the linear expansion ratio of the base material 402 and the optical film 42 conform to each other in the directions of the adhesive surface 40a. Consequently, a head-up display device including a mirror that is less likely to deform can be obtained.

[Modifications]

Although the embodiments have been described in detail above, the present invention is not limited to a specific embodiment, and various modifications and changes may be made within the scope of the claims. Furthermore, all of or some of the constituent elements of the embodiments described above may be combined.

The configuration of the optical film may be employed in a touch panel film, a transmissive polarizing plate, and the like. When these optical films are applied, preferably, the optical film should be applied not only to a mirror used in a head-up display device but also to a display device in which the optical film is provided to transmit display light.

For example, a modification may be configured as a display device provided with a display unit which emits display light, an optical film which transmits the display light, a base material which is formed of a synthetic resin material and to which the optical film is adhesively attached, and an adhesion layer which adhesively attaches the optical film to the base material. Even if the above case applies, the possibility of the optical film having an air bubble and peeling by volatilized gas produced from the base material can be reduced. In this case, the base material should preferably be made of a transparent synthetic resin.

Further, it is sufficient if the base material indicated in the first embodiment is formed of a synthetic resin material having high rigidity.

Each of the embodiments discloses a mode in which conformity in the tendencies of the linear expansion ratio of the base material and the optical film is realized in two directions orthogonal to each other in the same plane. More preferably, the two should further conform to each other in the linear expansion coefficients. In a mirror configured in this way, the amount of deformation which occurs at a temperature change can further be reduced.

In the mirror, a shaft portion and a flange portion need not be formed integrally. However, in a mirror formed by adhesively attaching an optical film to a base material, a degree of freedom in design of the base material is more increased than a configuration in which a reflection surface is deposited directly onto a base material. Therefore, when the mirror needs to include mechanical components such as the shaft portion and the flange portion, the number of parts can be reduced and cost reduction can be achieved by forming such mechanical components integrally with the base material.

The base material has been exemplified as the base material 40 of a substantially rectangular shape. The base material of a substantially rectangular shape may be trapezoidal as seen in plan view from the front likewise the base material 40 illustrated in FIG. 4. Also, the substantially rectangular shape may be a trapezoidal shape with corner portions cut off, for example. Furthermore, it suffices that the substantially rectangular shape is a shape for which at least the longer-side direction and the shorter-side direction can be identified.

It has been disclosed that the base material contains a fiber filler as the filler. The base material may also contain other fillers such as talc, in addition to the fiber filler. In other words, it suffices that the base material partially contains a filler which exhibits an anisotropy in at least the linear expansion ratio.

In FIG. 7, an embodiment in which the gate G4 is formed at an upper end portion of the base material 402 is disclosed. Alternatively, the gate may be formed at a lower end portion of the base material 402.

In the above configuration, since the gate exists at a position where the gate is not visually recognized when the base material is viewed through an opening in the housing, the configuration is desirable in terms of the outer appearance, and the possibility of stray light being caused by irradiation of sunlight onto the gate can be reduced.

In each of the embodiments, a mode in which the flange portion and the shaft portion are integrally formed is disclosed. These elements do not need to be formed integrally, and the base material may be adhesively attached to a holder on which a shaft portion or the like is further formed.

Moreover, the shaft portion should preferably be provided on both sides with reference to the base material 40 in a direction in which the base material 40 does not tend to linearly expand. According to this configuration, for the base material 40, stress received by the shaft portion due to the linear expansion of the base material 40 can be reduced, and as a consequence, a mirror that is less likely to deform can be obtained.

In addition, when the base material is to be injection molded, after the base material has been formed as a wider member, an outer edge portion where the desired filling direction cannot be obtained due to turning of the resin may be removed by cutting or polishing. By doing so, a more uniform filling direction may be realized.

The head-up display device of the present disclosure may be mounted on not only a car but also a vehicle such as a work vehicle or a motorcycle, a vessel, and an aircraft.

### REFERENCE SIGNS LIST

100 Head-up display device
1 Housing
10 Opening portion
11 Translucent cover
2 Display unit
3 Plane mirror
4 Reflection portion
40 Base material
40a Adhesive surface
41 Adhesion layer
42 Optical film
5 Reflection portion rotation mechanism
200 Windshield
L Display light
S Shaft portion
F Flange portion
V Virtual image position
G1 to G4 Gate

1. A head-up display device comprising:
a display unit which emits display light;
a base material which includes an adhesive surface and is formed of a synthetic resin material containing a fiber filler; and
an optical film which is adhesively attached to the adhesive surface and reflects the display light, wherein
when a first direction and a second direction that are orthogonal to each other are defined in directions of the adhesive surface, the optical film tends to linearly expand in the second direction in the directions of the adhesive surface, and
the base material tends to linearly expand in the second direction in the directions of the adhesive surface.

2. The head-up display device according to claim 1, wherein the optical film reflects, among beams of incident light, first direction visible polarized light, and transmits or absorbs second direction visible polarized light.

3. A head-up display device comprising:
a display unit which emits display light;
a base material which includes an adhesive surface and is formed of a synthetic resin material containing a fiber filler; and
an optical film which is adhesively attached to the adhesive surface and reflects the display light, wherein
when a first direction and a second direction that are orthogonal to each other are defined in directions of the adhesive surface, the optical film tends to linearly expand in the second direction in the directions of the adhesive surface, and
the base material includes a gate in the first direction in the directions of the adhesive surface.

4. The head-up display device according to claim 3, wherein the optical film reflects, among beams of incident light, first direction visible polarized light, and transmits or absorbs second direction visible polarized light.

5. A head-up display device comprising:
a display unit which emits display light;
a base material which includes an adhesive surface, is formed of a synthetic resin material containing a fiber filler, and is of a substantially rectangular shape; and
an optical film which is adhesively attached to the adhesive surface and reflects the display light, wherein
when a longer-side direction and a shorter-side direction are defined in directions of the adhesive surface, the optical film reflects, among beams of incident visible light, longer-side direction visible polarized light, and transmits or absorbs shorter-side direction visible polarized light, and
the base material includes a gate at a place corresponding to a center of a short side of the base material.

6. A head-up display device comprising:
a display unit which emits display light;
a base material which includes an adhesive surface, is formed of a synthetic resin material containing a fiber filler, and is of a substantially rectangular shape; and
an optical film which is adhesively attached to the adhesive surface and reflects the display light, wherein
when a longer-side direction and a shorter-side direction are defined in directions of the adhesive surface, the optical film reflects, among beams of incident visible light, longer-side direction visible polarized light, and transmits or absorbs shorter-side direction visible polarized light, and
the base material includes gates respectively provided at places corresponding to a center of both of long sides of the base material.

7. A head-up display device comprising:
a display unit which emits display light;
a base material which includes an adhesive surface, is formed of a synthetic resin material containing a fiber filler, and is of a substantially rectangular shape; and
an optical film which is adhesively attached to the adhesive surface and reflects the display light, wherein
when a longer-side direction and a shorter-side direction are defined in directions of the adhesive surface, the optical film reflects, among beams of incident visible light, longer-side direction visible polarized light, and transmits or absorbs shorter-side direction visible polarized light, and
the base material includes a gate only at a place corresponding to a center of one of long sides of the base material.

8. The head-up display device according to claim 1, wherein the optical film transmits or absorbs incident infrared light.

9. The head-up display device according to claim 1, wherein the optical film is formed of a dielectric multilayer film.

10. The head-up display device according to claim 1, wherein the fiber filler comprises a carbon fiber or a glass fiber.
